(19) United States
(12) Patent Application Publication
(10) Pub. No.: US 2010/0259768 A1
(43) Pub. Date: Oct. 14, 2010

(54) DISPLACEMENT DEVICE WITH PRECISION MEASUREMENT

(75) Inventors: Petrus Carolus Maria Frissen, Beek (NL); Renatus Gerardus Klaver, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/738,587

(22) PCT Filed: Oct. 17, 2008
(86) PCT No.: PCT/IB08/54269

§ 371 Date: Apr. 16, 2010

Related U.S. Application Data
(60) Provisional application No. 60/981,118, filed on Oct. 19, 2007.

(51) Int. Cl. G01B 11/14

(52) U.S. Cl. 356/614

(57) ABSTRACT

A displacement device with precision measurement with a displacement device for supporting a workpiece including an optical sensor (52); a support plate (54) defining a support plate aperture (56); a planar motor (58) disposed parallel the support plate (54), the planar motor (58) having a first side (60) operable to support the workpiece (40) and a second side (62) opposite the support plate (54); and a 2D-grating (68) disposed on the planar motor (58), the 2D-grating (68) being in optical communication with the optical sensor (52) through the support plate aperture (56).

This invention relates generally to displacement devices, and more specifically to displacement devices with precision measurement.

Increased precision in manufactured components requires increased precision in measurement. Precision is required in the manufacture, inspection, and repair of precision components, such as semiconductor integrated circuits. For example, displacement devices move semiconductor wafers to expose the surface of the semiconductor wafers to beams of various wavelengths for various purposes. Optical or ultraviolet (UV) beams can be used for photolithography, optical or electron beams can be used for inspection, and ion beams can be used for repair. The motion of the semiconductor wafer must be precise to locate the beam at the minute features being created or already created on the wafer. Precise motion requires precise measurement.

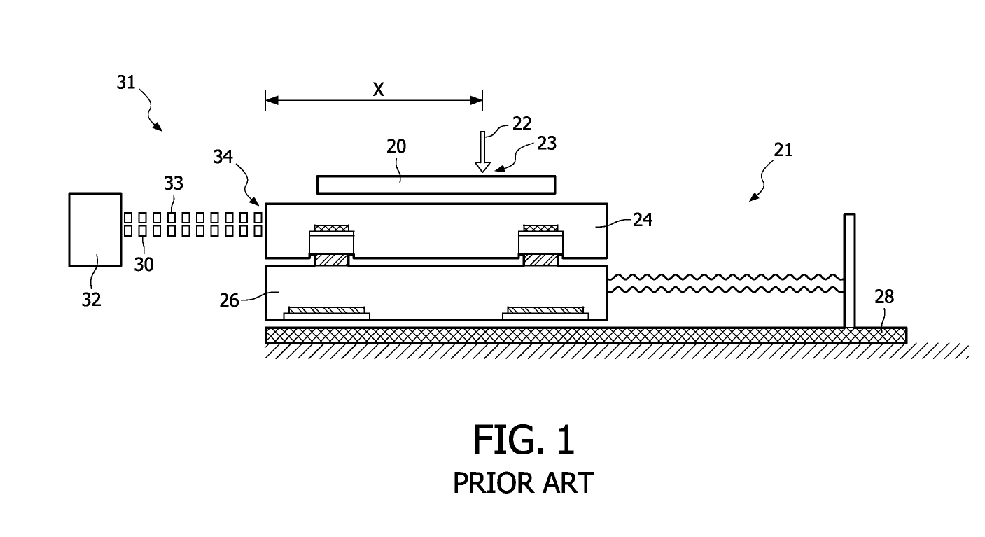

FIG. 1 is a schematic side view of a displacement device made in accordance with the prior art. A short stroke carrier 24 of displacement device 21 supports a wafer 20 that is exposed to a work beam 22. A long stroke carrier 26 supports the short stroke carrier 24 relative to magnet plate 28. Interferometry system 31 measures the position of the short stroke carrier 24. Interferometer control unit 32 directs a light beam 30 onto the measuring point 34 of the vertical side of the short stroke carrier 24. The interferometer control unit 32 compares a reflected beam 33 to a reference beam to determine the distance between the interferometer control unit 32 and the measuring point 34. This distance is then used to determine the position of the working point 23 where the work beam 22 should hit the wafer 20.

Unfortunately, the present measurement system has a number of limitations. The distance X between the measuring point 34 and the working point 23 is large, such as 400 millimeters for photolithographic applications, compounding any uncertainties in measurement. Typically, precision of 1 nanometer in the plane of the wafer 20 and 7 nanometer out of the plane of the wafer 20 is required. Small changes in temperature of the short stroke carrier 24 caused by beam exposure, internal magnetic coils, and internal cooling, result in significant changes to the distance X and loss of precision. One approach to minimize this effect has been to make the short stroke carrier 24 from materials with small thermal expansion coefficients, such as Zerodur° glass ceramic material. This is not a satisfactory solution, however, because the material is expensive and heavy.

It would be desirable to have a displacement device with precision measurement that overcomes the above disadvantages.

One aspect of the present invention provides a displacement device for supporting a workpiece including an optical sensor; a support plate defining a support plate aperture; a planar motor disposed parallel the support plate, the planar motor having a first side operable to support the workpiece and a second side opposite the support plate; and a 2D-grating disposed on the planar motor, the 2D-grating being in optical communication with the optical sensor through the support plate aperture.

Another aspect of the present invention provides a displacement device for supporting a workpiece including a plurality of optical sensors; a support plate defining a plurality of support plate apertures; a planar motor disposed parallel the support plate, the planar motor having a first side operable to support the workpiece and a second side opposite the support plate; and a 2D-grating disposed on the planar motor, the 2D-grating being in optical communication with the plurality of optical sensors through the plurality of support plate apertures. The number of the plurality of optical sensors is at least a determinative measurement number.

Another aspect of the present invention provides a displacement device for supporting a workpiece including means for moving the workpiece; means for supporting the moving means, the supporting means defining an aperture; and means for sensing translation and rotation of the moving means through the aperture at a measuring point disposed on the moving means.

The foregoing and other features and advantages of the invention will become further apparent from the following detailed description of the presently preferred embodiment, read in conjunction with the accompanying drawings. The detailed description and drawings are merely illustrative of the invention rather than limiting, the scope of the invention being defined by the appended claims and equivalents thereof.

FIG. 1 is a schematic diagram of a displacement device made in accordance with the prior art;

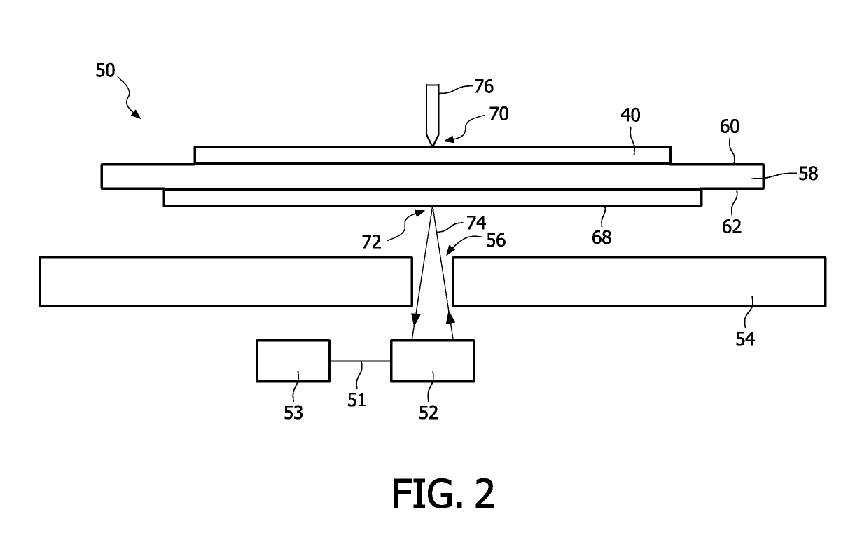

FIG. 2 is a schematic diagram of a displacement device made in accordance with the present invention;

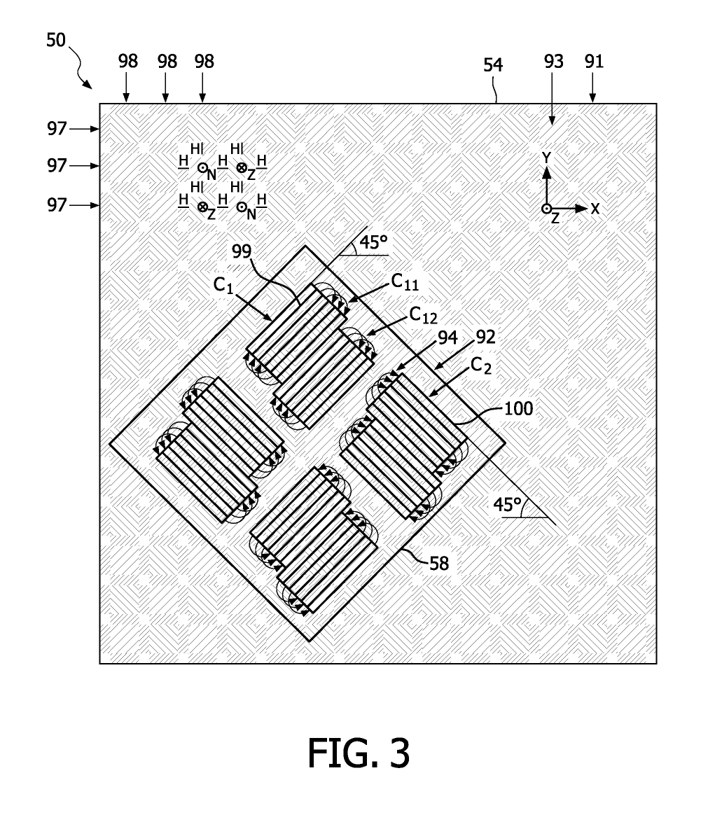

FIGS. 3-6 are schematic diagrams of a support plate and planar motor for a displacement device made in accordance with the present invention;

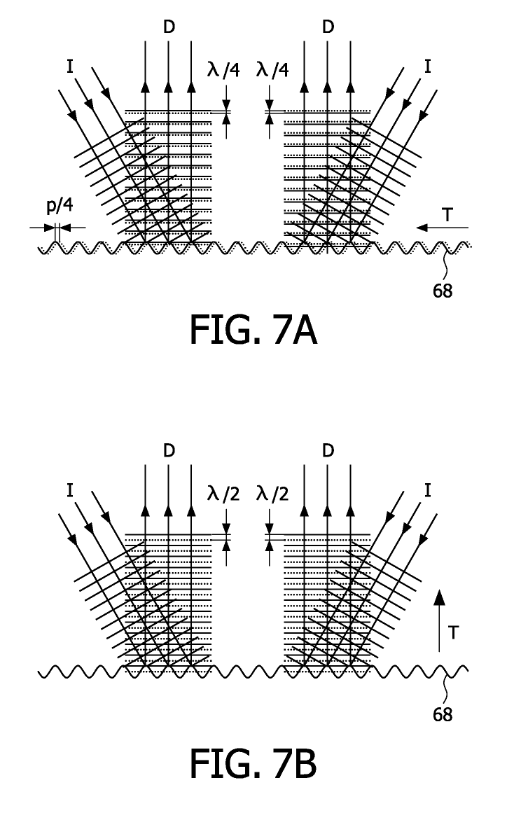

FIGS. 7-9 are schematic diagrams of an optical sensor and 2D-grating for a displacement device made in accordance with the present invention;

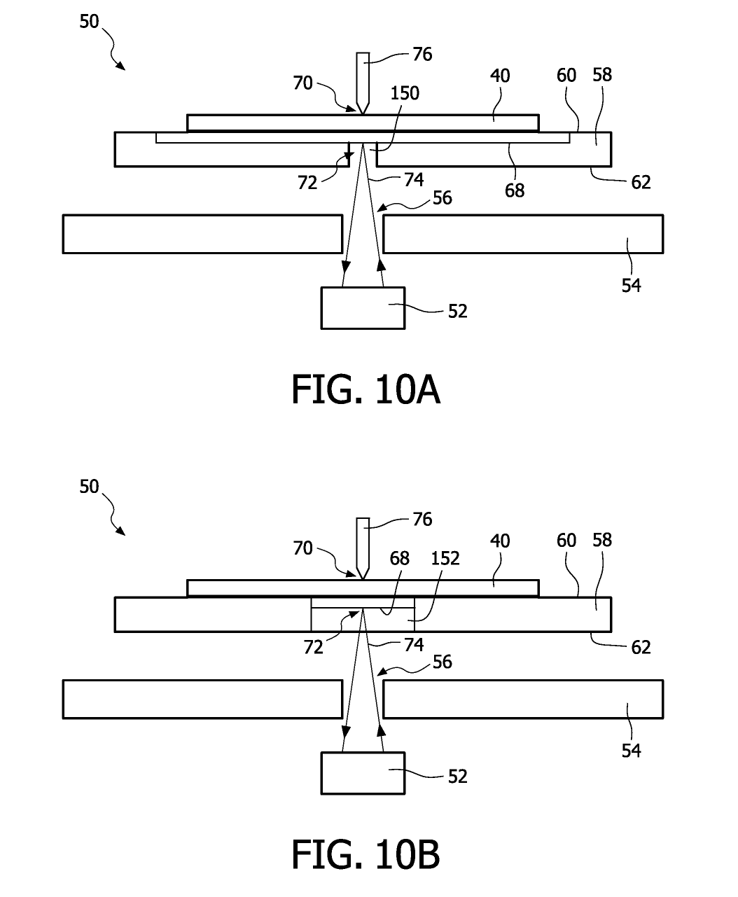

FIGS. 10A-10B are schematic diagrams of additional embodiments of a displacement device made in accordance with the present invention;

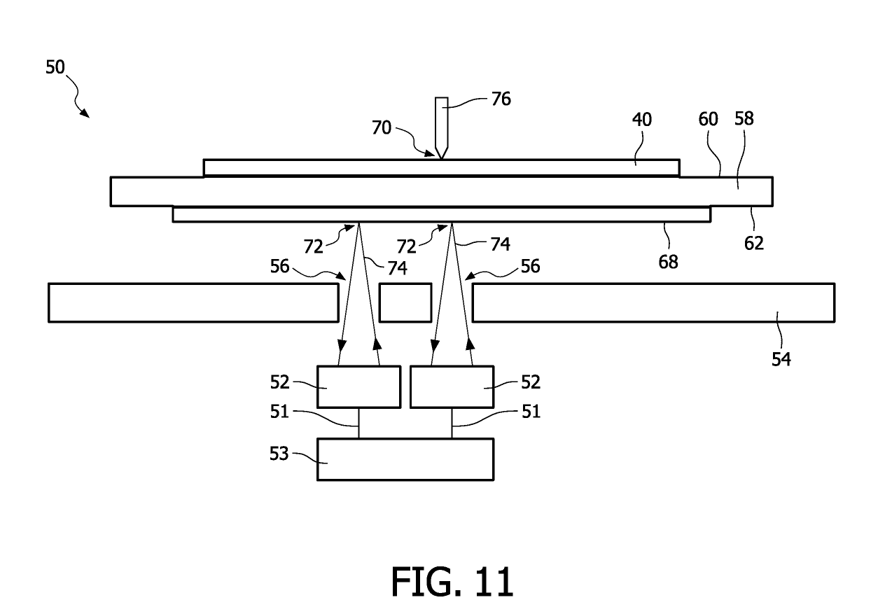

FIG. 11 is a schematic diagram of another embodiment of a displacement device made in accordance with the present invention; and

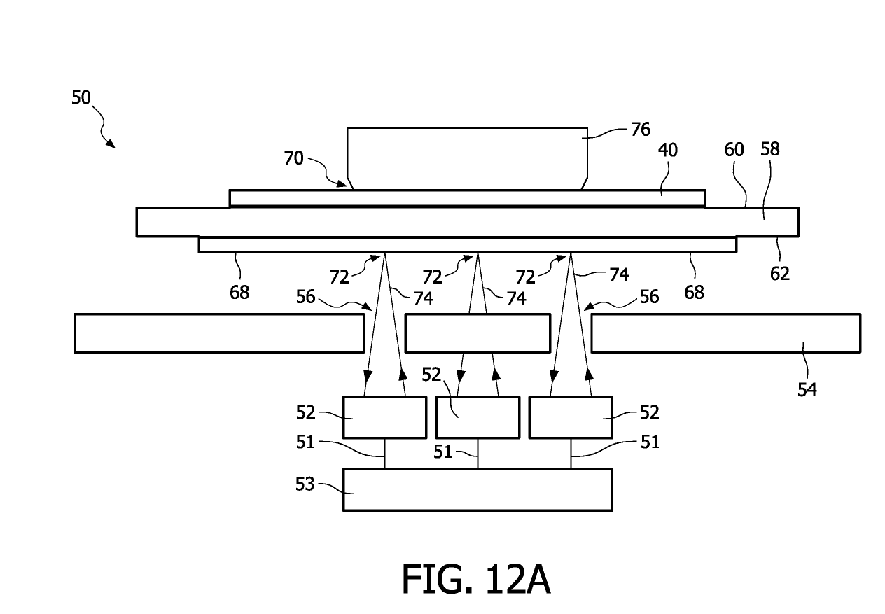

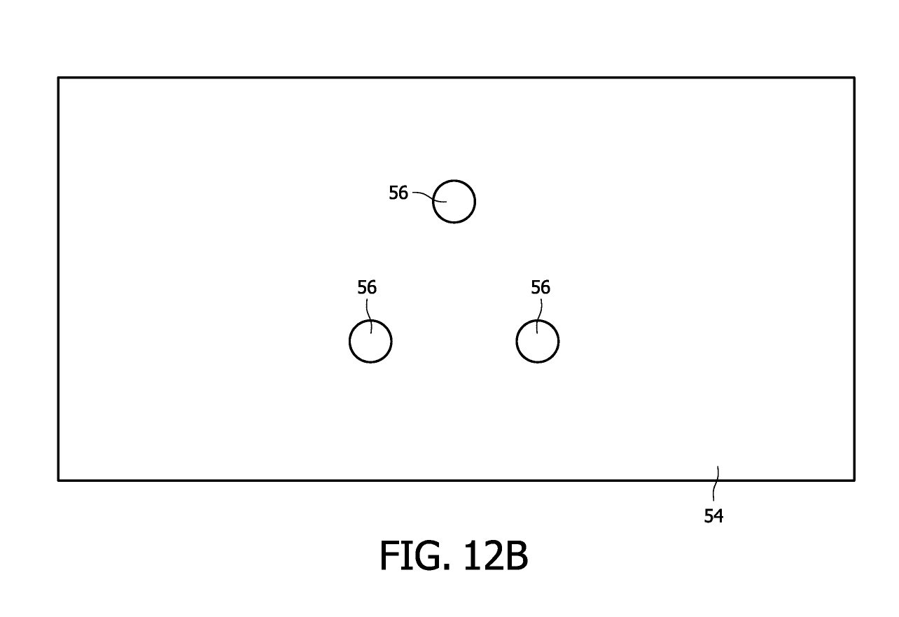

FIGS. 12A-12B are schematic diagrams of yet another embodiment of a displacement device made in accordance with the present invention.

FIG. 2 is a schematic diagram of a displacement device made in accordance with the present invention. The displacement device 50 can support a workpiece 40 and includes an optical sensor 52; a support plate 54 defining a support plate aperture 56; a planar motor 58 disposed parallel the support plate 54, the planar motor 58 having a first side 60 operable to support the workpiece 40 and a second side 62 opposite the support plate 54; and a 2D-grating 68 disposed on the planar motor 58, the 2D-grating 68 being in optical communication with the optical sensor 52 through the support plate aperture 56. The support plate 54 electromagnetically supports and moves the planar motor 58, which supports the workpiece 40. The optical sensor 52 can provide a position information signal 51 to a processor 53. When a number of optical sensors 52 are used, the processor 53 can receive a number of position information signals 51 from the number of optical sensors 52.

In this example, the optical sensor 52 is located across the planar motor 58 from a working point 70 on the workpiece 40, with the planar motor 58 including magnets and the support plate 54 including coils. The working point 70 can be a sharp point as illustrated or a broad plane over the surface of the workpiece 40. The measuring point 72 where the sensing beam 74 from the optical sensor 52 strikes the 2D-grating 68 is near the working point 70 where the working beam 76 strikes the workpiece 40, so that the position of the working point 70 can be precisely determined. The planar motor 58 is typically in the range of 2 to 5 millimeters thick. In this example, the optical sensor 52 is a six-degree-of-freedom optical sensor, i.e., an optical sensor measuring three degrees of translation and three degrees of rotation, and the 2D-grating 68 is disposed on the second side 62 of the planar motor 58. A measurement repeatability of 0.1 nanometer for translation and 1 microrad for rotation can be achieved using a six-degree-of-freedom optical sensor. Those skilled in the art will appreciate that the accuracy is also dependent on the quality of the 2D-grating. In one embodiment, the 2D-grating 68 is a transparent body, such as a body made of polycarbonate, with the grating pattern printed on the side of the 2D-grating 68 adjacent to the second side 62 of the planar motor 58. Such grating patterns can be printed using holography, interferometry, lithography, or the like. In another embodiment when more than one optical sensor is used, the 2D-grating 68 can be one large grating or a number of separate gratings disposed at particular points about the planar motor 58 to receive the sensing beams 74 from the optical sensors 52.

The workpiece 40 can be any workpiece that needs to be moved and precisely positioned. The working beam 76 is applied to the workpiece 40 at the working point 70 to achieve the desired effect on the workpiece 40. Examples of working beams include visible light beams, ultraviolet (UV) beams, extreme ultraviolet beams, electron beams (e-beams), ion beams, or the like. Visible light beams, ultraviolet (UV) beams, extreme ultraviolet beams, electron beams (e-beams) can be used for photolithography or inspection, and ion beams can be used for repair. Typically, the workpiece 40 is a thin planar object, such as a wafer. In one example, the workpiece is a semiconductor wafer. In another example, the workpiece is a printed circuit board. Those skilled in the art will appreciate that the working beam 76 need not contact the workpiece 40 at a sharp point as illustrated in FIG. 2. The working beam 76 can spread over all or part of the workpiece 40 so that the working point 70 is not a sharp point, but a broad plane over the surface of the workpiece 40. For example, the workpiece 40 can be a die with dimensions of 26×32 millimeters and the working beam 76 can spread over the full 26×32 millimeters.

The 2D-grating 68 can be a grating with a structure that is periodic in two directions which do not coincide. One example of such a structure is a checkerboard pattern. The 2D-grating 68 is shown as having substantial thickness for clarity of illustration, although the thickness can be minimal. The 2D-grating 68 can be an integral component, such as a transparent sheet with a grating pattern printed on the transparent sheet, affixed to the planar motor 58, or can be part of the planar motor 58 itself. In another embodiment, one or more Z-gratings can be disposed adjacent the 2D-grating 68 to form a 3D-grating.

FIGS. 3-6, in which like elements share like reference numbers with FIG. 2 and each other, are schematic diagrams of a support plate and planar motor for a displacement device made in accordance with the present invention. The support plate aperture through the support plate 54 and 2D-grating on the planar motor 58 have been omitted for clarity of illustration. The support plate 54 electromagnetically floats the planar motor 58 supporting a workpiece, as described in WIPO International Publication WO 2006/075291 A2, incorporated herein in its entirety by reference.

Referring to FIG. 3, the displacement device 50 includes a first part 91 formed by a system 93 of magnets, and a second part 92 formed by an electric coil system 94. The magnets are secured onto the planar motor 58 and the coil system is secured onto the support plate 54. The first and the second parts 91, 92 can move with respect to each other. In this example, the stationary part is the support plate 54 with the magnets, and the movable part is the planar motor 58 with the coils.

The magnets of the magnet system 93 are arranged in a pattern of rows 97 extending parallel to the X-direction, and columns 98 extending parallel to the Y-direction, the interspace between the rows and between the columns being the same. In each row 97 and in each column 98, magnets of a first type N and of a second type Z are alternately arranged. The magnets of the first type N have a direction of magnetization which extends at right angles to the planar motor 58 and towards the second part 92 with the electric coil system 94, while the magnets of the second type Z have a direction of magnetization which extends at right angles to the planar motor 58 and away from the second part 92 with the electric coil system 94. In each row 97 and in each column 98, a magnet of a third type H is arranged between each pair of magnets of the first type N and the second type Z. The direction of magnetization of the magnets of the third type H which are situated between the columns 98, extends parallel to the Y-direction and towards the adjacent magnet of the first type N, while the direction of magnetization of the magnets of the third type H which are situated between the rows 97, extends parallel to the X-direction and also towards the adjacent magnet of the first type N. Arrows indicate the directions of magnetization of the different types of magnets N, Z, and H.

The electric coil system 94 is provided with at least one coil of a first type C₁ whose current conductors 99, which are situated in the effective magnetic field of the magnets, include an angle of 45° with the X-direction, and the electric coil system 94 is also provided with at least one coil of a second type C₂ having current conductors 100, which are also situated in the effective magnetic field of the magnets, include an angle of 45° with the X-direction, and extend perpendicularly to the current conductors 99 of the coil of the first type C₁. As used herein, “current conductors in the effective magnetic field” means that part of the coil, generally a bunch of current conductors, is situated in the magnetic field of the magnets, and that an effective Lorentz force is exerted on the part of the coil, causing a movement of the coil.

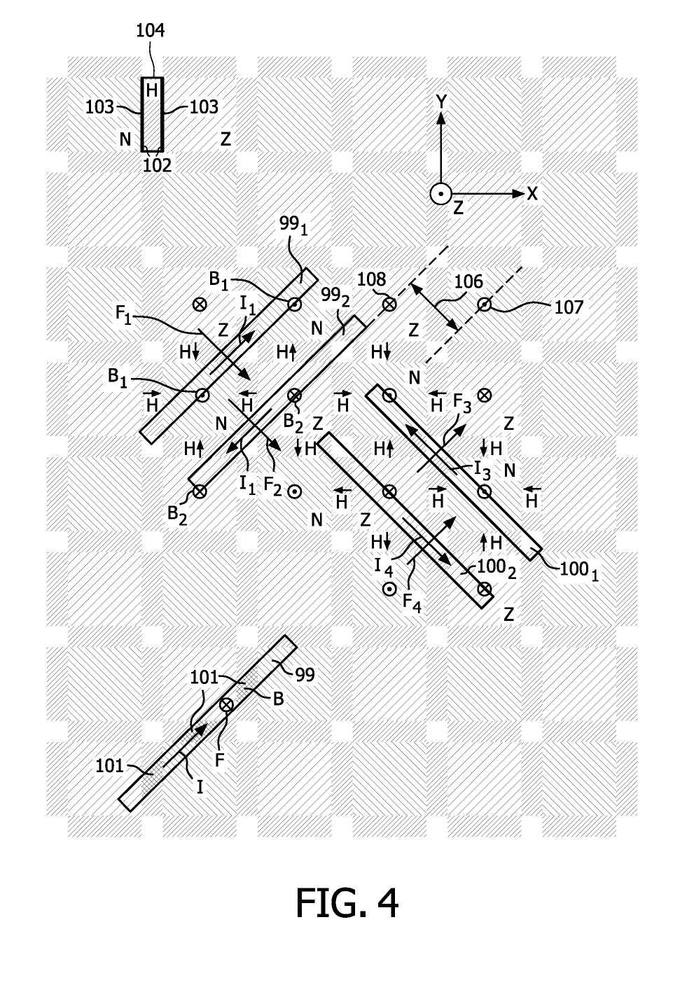

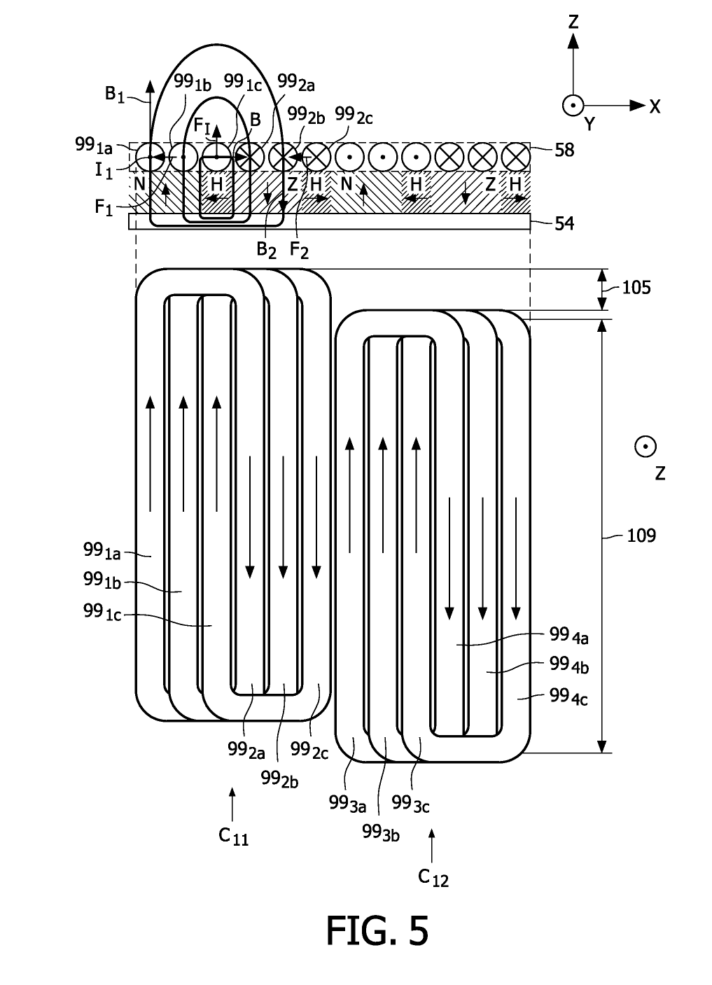

Referring to FIG. 4 to explain the manner in which the coils move in the system of magnets, the reference numerals 99₁, 99₂ and 100₁, 100₂ represent current conductors of the coils C₁ and C₂, respectively, which are provided in the magnetic fields of the magnets. Current conductor 99₁ is situated predominantly in the magnetic fields of the magnets indicated by the letter N. The direction of magnetization of these N magnets is indicated by an arrow pointing upwards, i.e., directed at right angles to the system of magnets and towards the current conductor 99₁. The arrow B1 indicates the direction of the magnetic field. When an electric current flows through the current conductor 99₁ in the direction indicated by the arrow I₁, a force F₁ is exerted on the current conductor in the direction indicated by the relevant arrow, as a result of which the current conductor wants to start moving in the direction of the arrow F₁. Current conductor 99₂ is predominantly situated in the magnetic fields of the magnets referenced Z. The direction of magnetization of the Z magnets is indicated by an arrow B₂ which points downwards, i.e., at right angles to the system of magnets and away from the current conductor 99₂. When an electric current flows through the current conductor 99₂ in accordance with the arrow I₂, i.e., counter to the current I₁, a force F₂ in the direction indicated by the relevant arrow is exerted on the current conductor 99₂, as a result of which the current conductor wants to start moving in the direction indicated by the arrow F₂, i.e., in the same direction as the arrow F₁. In the same manner, the current conductors 100₁ and 100₂, which are arranged at right angles to the current conductors 99₁ and 99₂, are subject to a force extending in the direction indicated by the arrows F₃ and F₄, under the influence of the magnetic fields of the N and Z magnets at a current in accordance with the arrows I₃ and I₄. When the currents in the current conductors are reversed, the force exerted on the current conductors, and hence the movement of the current conductors, is also reversed. This interplay of forces is also shown In FIG. 5.

Referring to FIG. 3, parts 101 of current conductors 99, 100 are also present above the magnets of the third type H and/or above parts where there is no magnet, i.e., between the magnets of the first type N and the second type Z. These parts of the current conductors are situated in a magnetic field B whose average direction extends substantially parallel to the X-Y plane. See also current conductor 99_{1c} in FIG. 4. Referring to FIG. 3, when a current I runs through this current conductor, the parts 101 of the current conductor is be subject to a force F in a direction perpendicular to the X-Y plane, i.e., the Z-direction. Depending on the direction of the current and the position of the current conductor with respect to the magnets, the force is directed towards the magnets or away from the magnets. When the force is directed away from the magnets, the force is referred to as the levitation force F₁, i.e., a force causing the current conductor to move away from the magnets. Such a force can be used to provide a bearing function between the support plate and the magnets.

The magnets of the first type N and the second type Z are square in shape. The magnets of the third type H are rectangular and dimensioned so that the longest side faces 102 of an H magnet border on the side faces 103 of an N magnet and a Z magnet, and the ratio between the dimension of the shortest side face 104 and the dimension of the longest side face 102 of a H magnet can lie in the range between 0.25 and 0.50 to provide the greatest strength of the magnetic field per unit area of the magnet system according to optimization analysis.

FIG. 5 illustrates two sets of three coils, i.e., a first set Cᵢᵢ with current conductors 99₁ₐ, 99_{1b}, 99_{1c} and return current conductors 99₂ₐ, 99_{2b}, 99_{2c}, and a second set C₂₁ with current conductors 99₃ₐ, 99_{3b}, 99_{3c} and return current conductors 99₄ₐ, 99_{4b}, 99_{4c}. Both sets of coils are fed by a three-phase current system. Viewed in the longitudinal direction of the current conductors, the first set C₁₁ of three current conductors is shifted over a distance 105, which is approximately half the pole pitch 106 of the magnets, with respect to the second set C₂₁ of three current conductors. The pole pitch 106 of the magnets as used herein is the distance between two adjacent diagonal lines on which the center points 107 and 108 of magnets of the same type, respectively, N and Z are situated. This avoids a variable torque being exerted on both sets of current-carrying coils during displacement, which causes an oscillating movement of the moving part (support plate or planar motor with magnets) around the Z-axis with respect to the stationary part. By shifting the sets of coils with respect to each other, this oscillating effect is substantially reduced because a torque develops in one of the two sets of coils which compensates for the torque in the other set. The oscillating effect could induce vibrations in the support plate 54 when the support plate 54 is the movable part.

The length 109 of the current conductors is selected to be approximately equal to k times the pole pitch 106 of the magnets, with k being a multiple of 2. As a result, the sum of the magnetic field remains approximately constant upon a movement of the current conductor in the longitudinal direction, causing fluctuations in the force exerted on the current conductor to be smaller. This is not dependent on the number of coils and phases.

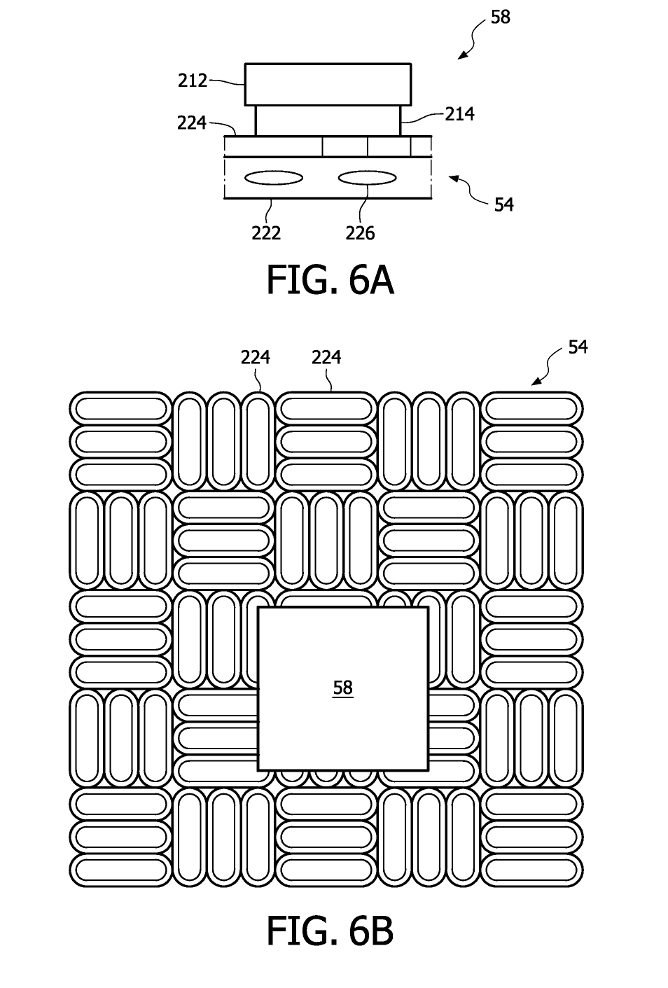

FIGS. 6A & 6B illustrate a cross-section and top view, respectively, of a displacement device with a first part or planar motor 58 and a second part or stationary support plate 54. In this example, the planar motor 58 includes a carrier 214 with a mirror block 212 on top of the carrier 214. The planar motor 58 can move with respect to the stationary support plate 54. Coils 224 are arranged on a coil block 222 that is fluid-cooled via cooling channels 226. The coils 224 are arranged in groups of three with the orientation of neighboring groups being offset by 90 degrees. Those skilled in the art will appreciate that other coil arrangements, such as groups of more or less than three coils, are possible as desired for a particular application. Those skilled in the art will further appreciate that in one embodiment, the coils are in the support plate 54 and the magnets are in the planar motor 58, while in another embodiment, the magnets are in the support plate 54 and the coils are in the planar motor 58.

FIGS. 7-9, in which like elements share like reference numbers, are schematic diagrams of an optical sensor and 2D-grating for a displacement device made in accordance with the present invention. The support plate with support plate aperture between the optical sensor 52 and the 2D-grating 68 has been omitted for clarity of illustration. The optical sensor 52 detects translation and rotation of the 2D-grating 68 attached to the planar motor supporting a workpiece. The optical sensor 52 is described in WIPO International Publication WO 2006/054258 A2, incorporated herein in its entirety by reference. Those skilled in the art will appreciate that the optical sensor 52 discussed below is a six-degree-of-freedom optical sensor operable to measure three degrees of translation and three degrees of rotation. The six-degree-of-freedom optical sensor can be converted to a three-degree-of-freedom optical sensor operable to measure three degrees of translation by omitting the position sensitive detectors. Those skilled in the art will appreciate that more than one three-degree-of-freedom optical sensor is required to measure the position of the 2D-grating 68 attached to the planar motor supporting a workpiece.

FIGS. 7A & 7B illustrate incident and diffracted light beams for the optical sensor 52. Two incident light beams I are provided at the 2D-grating 68 from different directions. The phase of each diffracted beam D is measured individually by measuring interference between an incident beam I and a diffracted beam D. Accordingly, a phase shift of λ/4 is measured for each pair of incident and diffracted beams for in-plane translation of pitch/4 (p/4) and a phase shift of λ/2 is measured for each pair for out-of-plane translations. To determine both the in-plane and out-of-plane translation, the system is arranged to distinguish phase shift contributions of the in-plane and out-of-plane translations. The in-plane translations can be determined optically or otherwise.

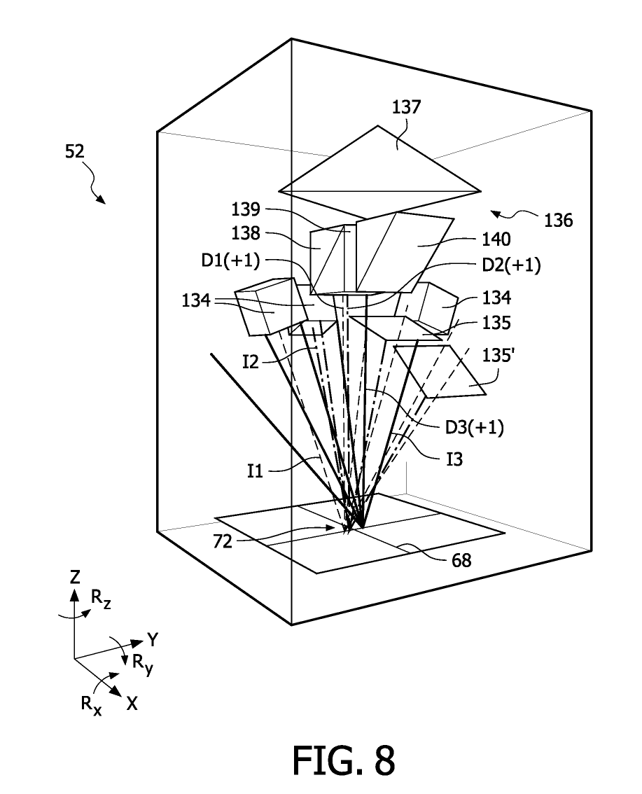

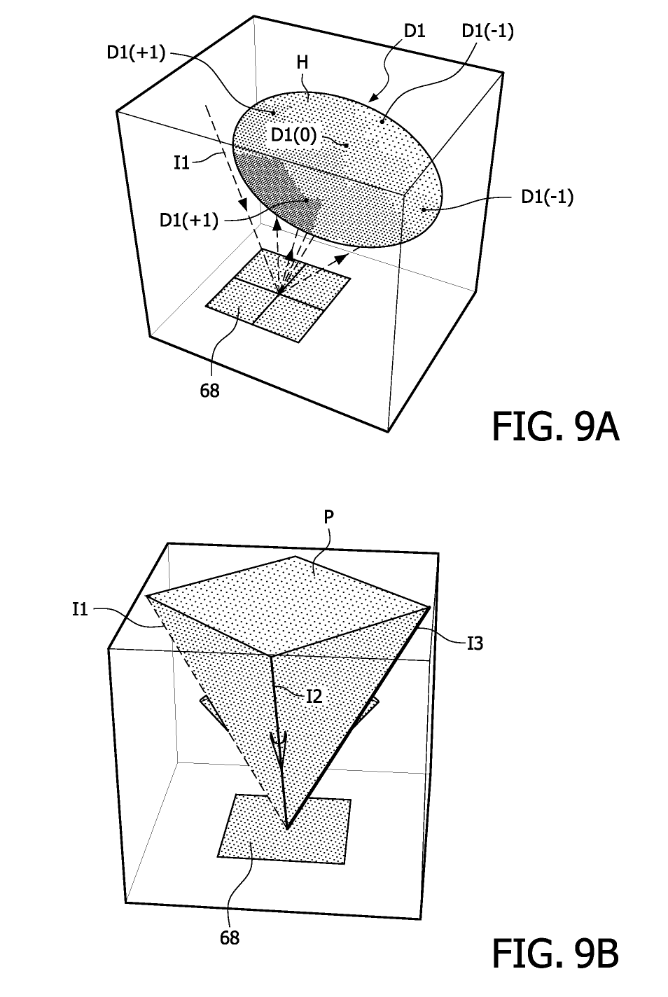

FIGS. 8, 9A, & 9B illustrate an exemplary optical sensor 52 for detecting translations T and rotation R of the planar motor (not shown) with a 2D-grating 68 applied to the planar motor. The optical sensor 52 includes optical heads 134 to provide first, second, and third incident light beams I1, I2, I3 from different directions to the 2D-grating 68. First, second, and third diffracted light beams D1, D2, D3 result from the incident light beams I1, I2, I3, respectively. The diffraction orders −1, 0, and +1 are shown for the diffracted beams D1, D2, D3. Pairs of incident I and diffracted beams D are indicated in black, dark-gray, and light gray. For clarity of illustration, the beams as shown in FIG. 8 do not coincide at the same measuring point 72, but at three different spots with a small offset between them. The three beams actually coincide at the same measuring point 72.

The optical heads 134 further include means for measuring the phase difference ΔΦ between at least one of the pairs consisting of the first incident beam I1 and the first diffracted beam D1, the second incident beam 12 and the second diffracted beam D2, and the third incident beam 13 and the third diffracted beam D3. As long as the optical power of the diffraction orders is sufficient, every diffraction order of the diffracted beams D1, D2, D3 can be used for measuring the phase difference ΔΦ. The wavelengths and angles of incidence of the beams I1, I2, I3 and the period p of the 2D-grating 68 are selected such that the diffraction order +1 of the diffracted beams D1, D2, D3 are used for detecting the translation T of the 2D-grating 68 with the optical heads 134.

The optical sensor 52 further includes position sensitive detectors 135, 135′ arranged to receive further orders of the diffracted light beams D1, D2, D3 to detect rotation R of the planar motor. A rotation Rx, Ry, Rz of the 2D-grating 68 results in a displacement of these orders on the position sensitive detectors 135, 135′ so that rotation of the planar motor can be detected. When the planar motor rotates, the phases of the diffracted beams D1, D2, D3 for measuring translation of the planar motor as the path length for one or more light beams may vary. Therefore, for a planar motor with a significant rotating motion component Rx, Ry, Rz, rotation should be determined to calculate the translation of the planar motor. The six-degree-of-freedom optical sensor can be converted to a three-degree-of-freedom optical sensor operable to measure three degrees of translation by omitting the position sensitive detectors.

More precisely, diffraction orders are indicated by two coordinates for a 2D-grating 68. The first order is indicated by (0,0), the first order in the x-direction by (1,0), the first order in the y-direction by (0,1), et cetera. In this example, the further orders (0,0) and (−1,0) are used for measuring the rotation of the planar motor. The order (0,0), hereinafter indicated again by order 0, is only sensitive to the rotations Rx and Ry, while higher orders, here (−1,0), are sensitive to Rx, Ry, and Rz. However, other further orders, such as (−1,−1), may be used as well. Hereinafter, the indication of the order by two coordinates is omitted for clarity. The diffracted +1st order beams D1, D2, D3 are directed to zero-offset retroreflector 136. After passing this retroreflector, the beams D1, D2, and D3 are directed to the 2D-grating 68 for a second time. Some of the diffracted beams are incident on the optical heads 134 and the phase of these further diffracted beams is measured to detect translation of the 2D-grating 68.

The diffracted orders 0 and −1 fall onto the two-dimensional position sensitive detector 135 and a one-dimensional position sensitive device 135′, respectively. The position of the spot of diffraction order 0 is measured in two directions with the two-dimensional position sensitive detector 135, whereas the position of the −1st order beam is measured in one direction with the one-dimensional position sensitive device 135′. The three phase measurements and the three spot position measurements are used to determine the three translations and three rotations of the 2D-grating 68. Exemplary position sensitive detectors are the NanoGrid Planar Encoder System available from OPTRA, Inc., of Topsfield, Mass., USA, and the PP 281 R Two-Coordinate Incremental Encoder available from Dr. Johannes Heidenhain GmbH, Traunreut, Germany. Those skilled in the art will appreciate that the higher dimension position sensitive detector can be used to measure fewer dimensions of translation. For example, a three-dimensional position sensitive detector can be used to measure two or one dimensions, or a two-dimensional position sensitive detector can be used to measure one dimension.

FIG. 9A illustrates one of a single incident beam I1 with its associated diffraction beam D1 of the orders +1, 0, and −1. Only the single incident beam is shown and other incident beams are omitted for clarity. The grating period p, the wavelength λ, and the angle of incidence are selected such that the diffracted +1st order beam in the plane of incidence is directed along the normal η of the 2D-grating 68. The virtual spherical surface H is illustrated to show the orientation of the diffraction orders more clearly. The cross-lines in the 2D-grating 68 show the orientation of the two-dimensional diffraction grating.

FIG. 9B illustrates the three incident light beams I1, I2, I3, with the three optical heads 134 positioned and oriented such that the three incident light beams I1, I2, I3 are directed along three edges of a virtual pyramid P. Referring to FIG. 8, the diffracted +1st order beams D1(+1), D2(+1) and D3(+1) in the plane of incidence of the three incident beams are parallel to each other and directed to the zero-offset retroreflector 136. This is typical for the beam layout in which the incident beams are directed along the edges of a virtual pyramid P. The function of the zero-offset retroreflector 136, hereinafter also referred to as zero-offset retroreflector, is to redirect an incoming beam such that the reflected beam is parallel to the incoming beam and also coincides with the incoming beam. The zero-offset retroreflector 136 comprises a cube corner 137, a polarizing beam splitter cube 138, a half wavelength plate 139, and a prism 140 acting as folding mirror. Normally, cube corners are used as retroreflectors. The incident and reflected beams are parallel to each other, but are spatially separated. The zero-offset retroreflector 136 redirects an incident beam along the same optical path back to the 2D-grating 68. If the direction or the position of the incident beam is not nominal, then the offset between the incident and reflected beams will not be zero. The configuration of the optical heads 134 depends on the method with which the phase of the diffracted beams D1, D2, D3 is measured. The measurement configurations can include several optical components as known in the art, such as wavelength plates for modifying the polarization of the incident light beam, optical splitters, and Faraday components.

The 2D-grating 68 can be a grating with a structure that is periodic in two directions which do not coincide. In one embodiment, the 2D-grating 68 is a checkerboard pattern. In another embodiment, one or more Z-gratings (not shown) can be disposed adjacent the 2D-grating 68 to form a 3D-grating. A multi-layer grating, such as a 3D-grating, allows measurement over an increased range of rotation of the planar motor 58 and/or a combination of a relative and an absolute measurement. A multi-layer grating is described in WIPO International Publication WO 2006/054255 A1, incorporated herein by reference.

FIGS. 10A-10B, in which like elements share like reference numbers with FIG. 2 and with each other, are schematic diagrams of additional embodiments of a displacement device made in accordance with the present invention. The 2D-grating can be disposed at various locations on the planar motor as desired for a particular application. The 2D-grating can be selected to reduce the distance between the working point and the measuring point, which reduces the error in determining the working point. FIG. 2 discussed above illustrates the 2D-grating disposed on the second side 62 of the planar motor 58. Those skilled in the art will appreciate that the various locations of the 2D-grating with associated planar motor apertures and transparent portions as illustrated in FIGS. 2, 10A, & 10B can be used for displacement devices employing a single optical sensor or a number of optical sensors.

Referring to FIG. 10A, the planar motor 58 defines a motor aperture 150 and the 2D-grating 68 is disposed over the motor aperture 150 at the first side 60 of the planar motor 58. The 2D-grating 68 can be attached to the first side 60 or can be located within the motor aperture 150 as desired for a particular application. In one embodiment, the 2D-grating 68 is a transparent body, such as a body made of polycarbonate, with the grating pattern printed on one side of the 2D-grating 68 adjacent the workpiece 40 and away from the first side 60 of the planar motor 58.

Referring to FIG. 10B, the planar motor 58 has a transparent portion 152 and the 2D-grating 68 is disposed on the first side 60 of the planar motor 58 on the transparent portion 152. The sensing beam 74 from the optical sensor 52 passes through the transparent portion 152 on the way to and from the measuring point 72. In one embodiment, the 2D-grating 68 is attached to the transparent portion 152 at the first side 60. In another embodiment, the 2D-grating 68 is formed as part of the transparent portion 152 at the first side 60, such as formation by printing on the transparent portion 152 of the planar motor 58, so that the print is next to the workpiece 40. Such grating patterns can be printed using holography, interferometry, lithography, or the like. In one embodiment, the transparent portion 152 extends across the whole width of the planar motor 58; i.e., the planar motor 58 is transparent.

FIG. 11, in which like elements share like reference numbers with FIG. 2, is a schematic diagram of another embodiment of a displacement device made in accordance with the present invention. In this embodiment, more than one optical sensor is used to provide additional precision. Additional optical sensors are particularly useful when the thickness of the planar motor is large to counteract the Abbé effect, i.e. the error resulting from pitch and yaw of the planar motor. When the measuring point 72 is directly across the planar motor 58 from a point sized working point 70 on the workpiece 40, the Abbé error resulting from the Abbé effect depends primarily on the distance between the measuring point 72 and the working point 70, i.e., the combined thickness of the 2D-grating 68, planar motor 58, and workpiece 40.

The displacement device 50 includes two optical sensors 52 determining the displacement of the planar motor 58 by detecting the motion of the 2D-grating 68 disposed on the planar motor 58. In this example, one optical sensor 52 is located across the planar motor 58 from a working point 70 on the workpiece 40 and the other optical sensor 52 is located across the planar motor 58 away from the working point 70. As defined herein, a component or point is located across the planar motor 58 away from the working point 70 when a line normal to the first side 60 of the planar motor 58 intersecting the working point 70 does not intersect the component or point. In another embodiment, both the optical sensors 52 are located across the planar motor 58 away from the working point 70. Those skilled in the art will appreciate that the locations of the optical sensors 52 can be selected as desired for a particular application, considering factors such as precision required, geometry of the displacement device components, components internal to the support plate that could interfere with placement of the support plate apertures, and the like.

The embodiment illustrated in FIG. 11 includes two optical sensors 52. The number of optical sensors 52 is selected at a minimum as a determinative measurement number, which is defined herein as the number of optical sensors required to determine position of a plane having six degrees of freedom. The determinative measurement number varies depending on the degrees of freedom of the particular optical sensors employed. In one embodiment, the determinative measurement number is one when the optical sensor 52 is a six-degree-of-freedom optical sensor making three translation measurements and three rotation measurements. In another embodiment, the determinative measurement number is three when the optical sensors 52 are two-degree-of-freedom optical sensors with each measuring two independent translations. For example, one optical sensor can measure X and Y translations, another optical sensor can measure Y and Z translations, and yet another optical sensor can measure X and Z translations. In yet another embodiment, the degrees-of-freedom can be different for the different optical sensors. For example, one optical sensor can be a three-degree-of-freedom optical sensor measuring X, Y, and Z translations, another optical sensor can be a two-degree-of-freedom optical sensor measuring X and Y translations, and yet another optical sensor can be a one-degree-of-freedom optical sensor measuring Z translations. Those skilled in the art will appreciate that the determinative measurement number for translation optical sensors is any number of optical sensors providing six independent translation measurements.

The number of optical sensors 52 can also be selected as greater than the determinative measurement number. For example, one six-degree-of-freedom optical sensor can be used with another optical sensor, such as a six-degree-of-freedom optical sensor, three-degree-of-freedom optical sensor, or one-degree-of-freedom optical sensor, to provide redundant position measurement. Because the measurements exceed the degrees of freedom of the planar motor, i.e., the position information is overdetermined, the measurements are converted into a calculated position. In one embodiment, the overdetermined measurements in a particular direction, such as the X translations, are averaged. In another embodiment, the overdetermined measurements are position weighted, such as weighting each measurement by the distance between the measuring point and the working point. The processor 53 receiving position information signals 51 from the optical sensors 52 can perform the conversion into a calculated position.

FIGS. 12A-12B, in which like elements share like reference numbers with FIG. 2, are schematic diagrams of yet another embodiment of a displacement device made in accordance with the present invention. FIG. 12A is a side view of the displacement device 50 and FIG. 12B is a top view of the support plate 54 illustrating the support plate apertures 56. In this example, the working beam 76 spreads over the workpiece 40 so that the working point 70 is a broad plane over the surface of the workpiece 40. Additional optical sensors are particularly useful when the thickness of the planar motor and/or the broad plane of the working point 70 is large to counteract the Abbé effect, i.e. the error resulting from pitch and yaw of the planar motor. When the working point 70 on the workpiece 40 is a plane rather than a point, the Abbé error in locating a particular point in the plane of the working point 70 depends both on the distance between the particular point and the measuring point 72, i.e., the combined thickness of the 2D-grating 68, planar motor 58, and workpiece 40, and the distance in the plane of the working point 70 between the particular point and the measuring point 72.

The optical sensors 52 can be any suitable optical sensors having the desired number of degrees of freedom for the particular application. As defined herein, the degree of freedom of an optical sensor is the independent number of translations and/or rotations the optical sensor can measure. In one embodiment, the optical sensors are six-degree-of-freedom, three-degree-of-freedom, two-degree-of-freedom, one-degree-of-freedom optical sensors, or a combination thereof. An exemplary six-degree-of-freedom is described in FIGS. 7-9 and associated text. The optical sensors can be position sensitive detectors, which are defined herein as optical sensors that can measure one or more directions of translation. Exemplary position sensitive detectors are the NanoGrid Planar Encoder System available from OPTRA, Inc., of Topsfield, Mass., USA, and the PP 281 R Two-Coordinate Incremental Encoder available from Dr. Johannes Heidenhain GmbH, Traunreut, Germany.

In the embodiment of FIGS. 12A-12B, three or more optical sensors are used to provide additional precision. The number of optical sensors is at least the determinative measurement number, which is defined herein as the number of optical sensors required to determine position of a plane having six degrees of freedom. Three two-degree-of-freedom optical sensors arranged in a triangular, non-linear pattern with 10 centimeter separation between the three measuring points can achieve a measurement repeatability of 0.1 nanometer for translation and 1 nanorad for rotation. Those skilled in the art will appreciate that the accuracy is also dependent on the quality of the 2D-grating. The number of optical sensors 52 can also be selected as greater than the determinative measurement number so that the position information is overdetermined A processor receiving position information signals from the optical sensors can perform a conversion into a calculated position.

The displacement device 50 includes three optical sensors 52 determining the displacement of the planar motor 58 by detecting the motion of the 2D-grating 68 disposed on the planar motor 58. In this example, the three optical sensors 52 are located across the planar motor 58 away from the working point 70 on the workpiece 40, although one of the optical sensors 52 can be located across the planar motor 58 from a working point 70 if desired. Those skilled in the art will appreciate that the locations of the optical sensors 52 can be selected as desired for a particular application, considering factors such as precision required, geometry of the displacement device components, components internal to the support plate that could interfere with placement of the support plate apertures, and the like.

Three-degree-of-freedom optical sensors can be used to measure translation and rotation since the optical sensors 52 are arranged in a triangular, non-linear pattern. For most applications, it is sufficient to separate the sensors at a distance comparable to the field of view of the system, i.e., the broad plane of the working point 70 over the surface of the workpiece 40. For example, in lithography, the field of view (also called dye size) is often 26×32 millimeters. In that case, a typical separation distance thus would be 30 millimeters. Six-degree-of-freedom optical sensors or a mixture of various degree-of-freedom optical sensors can also be used. Additional optical sensors can be added as desired for a particular application. When the working point 70 is a sharp point rather than a broad plane, the measuring points 72 can be near the working point 70 or can be at the edges of the workpiece 40 as desired.

While the embodiments of the invention disclosed herein are presently considered to be preferred, various changes and modifications can be made without departing from the scope of the invention. The scope of the invention is indicated in the appended claims, and all changes that come within the meaning and range of equivalents are intended to be embraced therein.

1. A displacement device for supporting a workpiece comprising:
an optical sensor (52);
a support plate (54) defining a support plate aperture (56);
a planar motor (58) disposed parallel the support plate (54), the planar motor (58) having a first side (60) operable to support the workpiece (40) and a second side (62) opposite the support plate (54); and
a 2D-grating (68) disposed on the planar motor (58), the 2D-grating (68) being in optical communication with the optical sensor (52) through the support plate aperture (56).

2. The device of claim 1 wherein the optical sensor (52) is located across the planar motor (58) from a working point (70) on the workpiece (40).

3. The device of claim 1 wherein the optical sensor (52) is a six-degree-of-freedom optical sensor.

4. The device of claim 1 wherein the 2D-grating (68) is disposed on the second side (62) of the planar motor (58).

5. The device of claim 1 wherein the planar motor (58) defines a motor aperture (150) and the 2D-grating (68) is disposed over the motor aperture (150) at the first side (60) of the planar motor (58).

6. The device of claim 5 wherein the 2D-grating (68) is a transparent body with a grating pattern printed on a side of the transparent body, the printed side being away from the first side (60) of the planar motor (58).

7. The device of claim 1 wherein the planar motor (58) has a transparent portion (152) and the 2D-grating (68) is disposed on the first side (60) of the planar motor (58) on the transparent portion (152).

8. The device of claim 7 wherein the 2D-grating (68) is printed on the transparent portion (152).

9. The device of claim 1 wherein the 2D-grating (68) is a transparent body with a grating pattern printed on the transparent body.

10. The device of claim 1 further comprising a grating disposed adjacent the 2D-grating (68) to form a 3D-grating.

11. A displacement device for supporting a workpiece comprising:
a plurality of optical sensors (52);
a support plate (54) defining a plurality of support plate apertures (56);
a planar motor (58) disposed parallel the support plate (54), the planar motor (58) having a first side (60) operable to support the workpiece (40) and a second side (62) opposite the support plate (54); and
a 2D-grating (68) disposed on the planar motor (58), the 2D-grating (68) being in optical communication with the plurality of optical sensors (52) through the plurality of support plate apertures (56);
wherein the number of the plurality of optical sensors (52) is at least a determinative measurement number.

12. The device of claim 10 wherein the optical sensors (52) are two-degree-of-freedom optical sensors.

13. The device of claim 10 wherein the optical sensors (52) are position sensitive detectors.

14. The device of claim 10 wherein the number of the plurality of optical sensors (52) is greater than the determinative measurement number, further comprising a processor (53) receiving a plurality of position information signals (51) from the plurality of optical sensors (52) and being operable to convert the plurality of position information signals (51) to a calculated position of the planar motor (58).

15. The device of claim 14 wherein the processor (53) is operable to convert the plurality of position information signals (51) to the calculated position by a method selected from the group consisting of averaging and position weighting.

16. The device of claim 10 wherein the 2D-grating (68) is a plurality of 2D-gratings.

17. The device of claim 10 wherein the 2D-grating (68) is disposed on the second side (62) of the planar motor (58).

18. The device of claim 10 wherein the planar motor (58) defines a motor aperture (150) and the 2D-grating (68) is disposed over the motor aperture (150) at the first side (60) of the planar motor (58).

19. The device of claim 18 wherein the 2D-grating (68) is a transparent body with a grating pattern printed on a side of the transparent body, the printed side being away from the first side (60) of the planar motor (58).

20. The device of claim 10 wherein the planar motor (58) has a transparent portion (152) and the 2D-grating (68) is disposed on the first side (60) of the planar motor (58) on the transparent portion (152).

21. The device of claim 20 wherein the 2D-grating (68) is printed on the transparent portion (152).

22. The device of claim 10 wherein the 2D-grating (68) is a transparent body with a grating pattern printed on the transparent body.

23. The device of claim 10 further comprising a grating disposed adjacent the 2D-grating (68) to form a 3D-grating.

24. A displacement device for supporting a workpiece comprising:
means for moving the workpiece;
means for supporting the moving means, the supporting means defining an aperture; and
means for sensing translation and rotation of the moving means through the aperture at a measuring point disposed on the moving means.
